(19) United States
(12) Patent Application Publication
(10) Pub. No.: US 2005/0141889 A1
(43) Pub. Date: Jun. 30, 2005

(54) Heating device and heating method for a fluid in a basin

(75) Inventor: Karsten Laing, Althutte (DE)

Correspondence Address: FOLEY & LARDNER, P.O. BOX 80278, SAN DIEGO, CA, 92138-0278, US

(73) Assignee: Oliver Laing, Karsten Laing, Birger Laing

(21) Appl. No.: 10/768,888

(22) Filed: Jan. 29, 2004

(30) Foreign Application Priority Data
Jan. 30, 2003 (DE) 103 04 398.5-34

(51) Int. Cl. H05B 3/60

(52) U.S. Cl. 392/322

(57) ABSTRACT

A heating device and method for a fluid in a basin is disclosed. The heating device includes a flow-through path which can be positioned outside a fluid reservoir of the basin. A heater is arranged in the flow-through path. The fluid can flow past the heater for the purpose of heating up the fluid. At least one heating element is arranged in the heater. An optimum switch-off control of the heating can be ensured with this arrangement. A temperature sensor may be positioned in the heater to be in thermal contact with the at least one heating element.

The present disclosure relates to the subject matter disclosed in German application No. 103 04 398.5-34 of Jan. 30, 2003, which is incorporated herein by reference in its entirety and for all purposes.

### BACKGROUND OF THE INVENTION

The invention relates to heating devices. In particular, the invention relates to heating devices for a fluid in a basin, such as a whirlpool, spa or bath tub, for example.

### SUMMARY OF THE INVENTION

According to one embodiment, a heating device for a fluid in a basin includes a flow-through path for a fluid reservoir of the basin. A heater is arranged in the flow-through path, the fluid being able to flow past the heater for the purpose of heating up. At least one heating element is arranged in the heater. A temperature sensor is positioned in the heater and is in thermal contact with the heating element.

The heater may include an area of solid material. The solid material preferably has a high thermal conductivity. The material for the area of solid material may be an electrical insulator. The heating element may be surrounded by the solid material. The temperature sensor may be surrounded by the solid material as well. The solid material may be arranged between the temperature sensor and the heating element.

In a preferred embodiment, the temperature sensor is freely positionable in a longitudinal direction of the heater, at least during production of the heater.

In another preferred embodiment, the temperature sensor is arranged in a recess of the heater. The recess may extend in a longitudinal direction of the heater.

The heater may have a metallic sleeve.

The temperature sensor is preferably seated at or near a highest point of the heater in the flow-through path with respect to the direction of gravity.

In a preferred embodiment, the flow-through path is formed in a tube. The tube may be adapted to be bent. The heater may be adapted to be bent with the tube.

The heater may include a heating rod seated in the flow-through path. The heating element may be an electric resistance heating element having an extension in a longitudinal direction of the heater.

In a preferred embodiment, the temperature sensor is arranged with a front end being offset in relation to an adjacent heating end of the heating element. The offset is preferably approximately 50 mm.

The circulation pump may be integrated with the flow-through path. The circulation pump may be coupled to an exit end of the flow-through path.

The heating device may also include a temperature monitoring device. The temperature sensor may be coupled to the device, which may be adapted to control operation of the heater. The device may be adapted to selectively switch on and off heating of the fluid. The temperature monitoring device may include an evaluating device for evaluating signals of the temperature sensor. The evaluating device may be adapted to determine the time-dependent increase in temperature. The evaluating device may be adapted to determine an absolute temperature.

The heating device may also include an additional temperature sensor for determining the temperature of fluid entering the flow-through path. The additional temperature sensor may be coupled to a temperature monitoring device.

The heating device may also include an additional temperature sensor for determining the temperature of fluid exiting from the flow-through path. The additional temperature sensor may be coupled to a temperature monitoring device.

The heating device may also include additional temperature sensors for determining temperatures at entry and exit of the flow-through path and an evaluating device adapted to determine the flow of fluid through the heating device via the entry temperature of the fluid into the flow-through path and the exit temperature out of the flow-through path or out of the heating device. A filter signal may be adapted to be generated via the determination of the through-flow of the fluid.

### BRIEF DESCRIPTION OF THE DRAWINGS

FIG. 1 shows a plan view of a basin, on which a heating device according to an embodiment of the invention is mounted;

FIG. 2 shows a side view of the arrangement of FIG. 1 in the direction A;

FIG. 3 shows a cross-sectional view of a flow-through loop of the heating device of FIG. 2 along line 3-3;

FIG. 4 shows an enlarged illustration of the area B of FIG. 2; and

FIG. 5 shows an exemplary course of the temperature over the time during dry running (steep curve) and with a blocked inlet or outlet (flatter curve).

### DETAILED DESCRIPTION OF CERTAIN EMBODIMENTS

The following description of preferred embodiments serves to explain the invention in greater detail in conjunction with the drawings.

In accordance with embodiments of the present invention, a heating device is provided such that an improved switch-off control of the heating is ensured.

This is accomplished in accordance with embodiments of the invention, in that a temperature sensor, which is in thermal contact with the at least one heating element, is positioned in the heater.

When fluid flows in the flow-through path, stationary temperature conditions ensue in the case where no malfunctions occur; the heater heats the fluid and heat is carried away from the heater by the fluid flowing past the heater. If the amount of fluid is reduced or the flow even ceases, the temperature is carried away from the heating elements of the heater only partially or even not at all, causing the region of the heating elements to heat up beyond nominal temperature. This heating up is detected by the temperature sensor. On account of the arrangement of the temperature sensor in the heater in thermal contact with the heating element or elements, deviations from the stationary temperature conditions may be measured exactly and with short reaction times.

Malfunctions may then be recognized early, and the heating can be switched off. On account of the short reaction times and the high accuracy which is brought about by the positioning of the temperature sensor in the heater, malfunctions can also be evaluated in order, for example, to determine whether the case of malfunction is a critical one, requiring a permanent switching off of the heating, or whether it is a less critical malfunction which does not require a permanent switching off. A switch-off control may then be realized which, on the one hand, avoids any unnecessary intervention of an operator on account of less critical malfunctions but, on the other hand, causes a permanent switching off of the heating of the heater with a short reaction time in the case of critical malfunctions. In the case of critical malfunctions, an operator has, for example, to see to it that the malfunction is eliminated whereas in the case of uncritical malfunctions intervention by an operator is not necessary.

In accordance with embodiments of the invention, an “intelligent” monitoring of dry running may be realized, with which less critical cases of malfunction can be recognized. In particular, the monitoring of dry running may be used in conjunction with large-area heating elements, such as resistance heating elements.

The temperature sensor may also protected mechanically in the heater in relation to external influences.

The temperature sensor may, for example, be a thermoelement or a resistance temperature sensor.

It is particularly advantageous when the heater comprises an area of solid material which is formed by a material having high thermal conductivity. This solid material is preferably a solid-state material, such as, for example, magnesium oxide.

Furthermore, it is favorable when the material for the area of solid material is an electrical insulator. A heating element may then be brought into mechanical contact with the solid material, whereby a reliable heat contact is again provided. As a result, heat may be effectively transferred from the heating element or elements in the heater to the fluid flowing past. Additionally, a good thermal contact may be provided with the temperature sensor in the heater as a result when this likewise touches the solid material.

In certain embodiments, the heating element or elements may to be surrounded by solid material in order to provide a good thermal contact via a good mechanical contact.

For the same reason, it may be preferable that the temperature sensor is surrounded by solid material.

When solid material is arranged between the temperature sensor and the at least one heating element, a good heat contact may be provided in this way between the at least one heating element and the temperature sensor and so the temperature in the heater can be determined in an efficient manner via the temperature sensor.

It is particularly advantageous when the temperature sensor can be freely positioned in a longitudinal direction of the heater at least during the production of the heater. The temperature sensor is then freely displaceable in the longitudinal direction of the heater at least during its production and can be affixed at an optimum or desired position in the heater. Flow-through paths or loops can have different shapes for different basins. They may, for example, be curved in different ways. Different optimum positions for the temperature sensor may result depending on the shape of the flow-through path. It can be ensured as a result of a free positionability at least during the production that the optimum position of the temperature sensor can always be set for a specific type of basin and, therefore, the temperature monitoring function can again be ensured in an optimum manner.

The temperature sensor can be arranged in a recess of the heater. The recess is formed, for example, by a small tube. The temperature sensor can then be freely positioned in the small tube at least during the production of the heater in a longitudinal direction of the small tube and, therefore, in a longitudinal direction of the heater. The small tube extends in the longitudinal direction of the heater, wherein the longitudinal direction of the small tube and the longitudinal direction of the heater are preferably substantially parallel to one another.

It is favorable when the heater has a metallic sleeve in order to protect the area of solid material of the heater. A metallic sleeve has a good coefficient of heat transfer in order to achieve an effective heating of the fluid which then flows past the sleeve of the heater.

It may be particularly advantageous when the temperature sensor is seated at or in the vicinity of a highest point of the heater in the flow-through path with respect to the direction of gravity (and the longitudinal direction of the heater) when a heating device is mounted on the basin. The highest location of the flow-through loop with respect to the direction of gravity is a particularly critical point since steam or air can accumulate at this location. Such an accumulation of steam or air occurs, for example, when a reduced amount of fluid is flowing through the flow-through path. The transfer of heat is worse in an area in which a bubble of steam or a cushion of air is seated, or in which a two-phase flow is present, than an area with a single-phase fluid flow. The heater may no longer be cooled effectively in such a two-phase flow area, which makes a safety switch-off necessary. When the temperature sensor is arranged just in this critical area, such an overheating, which can be only local, can be registered in a rapid and reliable manner in order to be able to carry out a quick safety switch-off again. In conjunction with the free positionability of the temperature sensor at least during the production of the heater (and the flow-through loop), the temperature sensor may be positioned at this point, which may be optimized with respect to the monitoring of safety, for every shape of the flow-through path. The highest point of the heater in the flow-through path refers in this respect essentially to the longitudinal direction of the flow-through path; the positioning of the temperature sensor at or in the vicinity of the highest point transversely to the longitudinal direction of the flow-through path is of secondary importance.

In a preferred embodiment, the flow-through path is formed in a tube. The heating device may then be produced in a simple manner.

In this respect, the tube can be bent so that the heating device can be mounted on the basin in any desired position or an adaptation to various basin shapes with different distances between fluid exit and fluid entry not only in a vertical direction, but also in a horizontal direction, may be carried out. If, for example, the tube is U-shaped in its initial position, the heating device can be mounted with the flow-through path by bending the tube accordingly even in the case of different basin sizes.

It is particularly advantageous when the heater with the at least one heating element can be bent with the tube.

In a preferred embodiment, the heater is designed as a heating rod which is arranged in the flow-through loop. The heating rod may be produced separately and then fixed in the tube in order to produce the flow-through path.

A low specific power density per area may be achieved when the heating element is an electric resistance element which has an extension in a longitudinal direction of the heater. As a result of such a heating element, an effective heating up of the fluid flowing past the heater may be brought about. Such a heating element may also be embedded in the heater in a simple manner.

It may be provided for the temperature sensor or an additional temperature sensor to be arranged with a front end at a distance in relation to an adjacent end or an adjacent heating end of the at least one heating element. As a result, the temperature sensor comes into contact with fluid which is flowing into the flow-through path out of the basin before the fluid comes into contact with the heating section of the flow-through path. The temperature sensor which is positioned in the flow-through path can then determine the temperature of the fluid in the basin and pass this temperature information to, for example, a primary control device. With a corresponding geometric arrangement of the temperature sensor with respect to the heating element or the heating elements, this temperature determination function may be brought about with respect to the fluid in the basin without any interference of the dry running protection function of the temperature sensor in the heater. For example, the temperature sensor can be arranged with its front end at a distance of about 50 mm in relation to the heating element or a heating end of the heating element.

It is favorable from the point of view of installation technology when a circulation pump is integrated. The heating device may then comprise a heating loop which corresponds to the flow-through path or a part of the flow-through path which is connected to the circulation pump. This unit consisting of circulation pump and heating device may be mounted on the basin as a whole.

In this respect, it may be provided for the circulation pump to be coupled to an exit end of the flow-through path. For example, an entry to the pump is coupled to an exit end of the flow-through path, from which fluid heated by the heater exits.

An intelligent switch-off control may be brought about when a time-dependent temperature measurement can be carried out by the temperature sensor in the heater. The development of the time-dependent temperature may be determined as a result, and relevant information can be ascertained, from this temporal development with respect to whether a critical case of malfunction is present requiring a permanent switching off of the heating and necessitate external intervention, or a less critical case of malfunction is present which would not seem to require a permanent switching off of the heating. In the latter case, the heating is automatically switched on again, for example, after a specific period of time, whereas, in the first case, external intervention is necessary. Less critical malfunctions are, for example, present when the flow of fluid is reduced; this may be caused by the fact that the entry is (temporarily) blocked. Such malfunctions are reversible and so a temporary switching off is sufficient. When steam is formed or when air is present in the flow-through loop, for example, a permanent switching off may be necessary.

It is particularly advantageous when a temperature monitoring device is provided, to which the temperature sensor is coupled and by means of which the heating in the flow-through path can be switched off. In principle, it may be possible for the temperature monitoring device to comprise a-simple switch which switches the heating off when a specific temperature is exceeded. According to embodiments of the present invention, an intelligent temperature monitoring device can assess malfunctions as to whether they are uncritical or critical. Corresponding signals may be transmitted to a primary control device or regulation device which may include a characterization of the malfunction. The temperature monitoring device can carry out actions which are adapted to the characteristics of the determined results of measurements. For example, a malfunction report can be displayed and a permanent switching off of the heating carried out in the case of critical malfunctions. Suitable reactions which are graded as a function of time can also be initiated. For example, reversible malfunctions, such as reversible stagnations, may be corrected, whereas a permanent dry running which continues over a certain period of time and leads to the formation of steam results in a permanent switching off of the heating and in a malfunction report.

In this respect, according to a preferred embodiment, the temperature monitoring device includes an evaluating device for signals of the temperature sensor. The evaluating device can draw corresponding conclusions from the signals of the temperature sensor and pass this information to a primary control device.

For example, the time-dependent increase in the temperature can be determined by means of the evaluating device. There are uncritical cases of malfunction and, reversible cases of malfunction which lead to a relatively slow increase in the temperature, such as, for example, a blockage of the circulation pump limited in time or a limited blockage of the entry point for fluid from the basin into the flow-through path. Dry running with formation of steam and the penetration of air, on the other hand, leads to a quicker rise in the temperature. The evaluating device can then ascertain the type of malfunction and the suitable reaction from the determination of the time-dependent increase in the temperature; for example, a permanent switching off of the heating may be brought about and a malfunction report transmitted in the case of a rapid rise in the temperature. For example, it is also apparent whether the exit of the basin is blocked only for a short time, because an operator may have held part of his body in front of this exit for a short time, or whether this exit is blocked for a longer period of time or the level of fluid has sunk below the exit. It is then advantageous when the temperature can be checked by the evaluating device alternatively or in addition. Cases of malfunction can then be assessed as to whether they are critical or uncritical. With critical cases, the heating is permanently switched off. Since with uncritical cases, for example, when an absolute temperature threshold is not exceeded, no permanent switching off has to be brought about, the number of unnecessary external operator interventions or the number of unnecessary malfunction reports scan also be minimized as a result and, therefore, the ease of operation may be increased.

In this respect, in an embodiment of the invention, an additional temperature sensor may be provided for determining the temperature of fluid entering the flow-through path. This temperature sensor for the entry temperature is preferably coupled to a temperature monitoring device. The temperature of the fluid in the basin can, for example, be determined via such a temperature sensor.

In addition, it is favorable when an additional temperature sensor is provided for determining the temperature of fluid exiting from the flow-through path. In this respect, this temperature sensor for the exit temperature may be coupled, to a temperature monitoring device.

Further, it is favorable when a temperature sensor for the entry temperature of fluid flowing through the flow-through path into the basin is provided. This temperature sensor can be formed by the temperature sensor for the exit temperature. Particularly in the case of basins with smaller fluid intake volumes, such as, for example, bath tubs, water which is too hot must be prevented from flowing into the basin. The temperature may be monitored by means of the temperature sensor and, when too high a value is detected, corresponding measures may be initiated, such as, for example, a switching off of the circulation pump.

In this respect, according to an embodiment of the invention, for the temperature of the fluid when entering the flow-through path is measured via the temperature sensor for the entry temperature and the temperature, of the fluid during or after exiting from the flow-through path is measured by the temperature sensor for the exit temperature and, with a known heating capacity, the flow of fluid through the heating device can then be determined.

A filter signal may be generated via the determination of the through-flow of the fluid. When, for example, the flow of fluid is reduced over a longer period of time (and, otherwise, no particular malfunctions are present), this indicates that a filter, through which the fluid must pass, is blocked and will be serviced or exchanged.

It is favorable when the switch-off temperature for the heating is set such that residual heat and overheating of the fluid when entering the basin are taken into consideration. As a result, fluid which is too hot can be prevented from flowing into the basin.

In addition, it is favorable when the temperature monitoring device includes a restart blocking device. This restart blocking device can be realized, for example, by means of a software solution. As a result, it may be ensured that the heating elements can cool down following a switching off of the heating. It is then possible to avoid too high a temperature being reached during repeated, successive switching on and off.

In addition, it is favorable when the temperature monitoring device takes an initial heating-up process into consideration. Normally, the temperature rises considerably following the initial switching on in the flow-through path when the fluid in the basin is still warm and hot fluid flows out of the basin into the flow-through path; this increase takes place before stationary conditions are reached. As a result of the control via the temperature monitoring device it can be made possible for no safety switch-off of the heating to be carried out at this stage but rather for the safety check with respect to switching off the heating to be carried out only in the stationary operation once the initial heating-up process has terminated. If, however, an absolute temperature which is too high is reached, a safety switch-off can also be carried out in the heating-up process. It is also possible to set a stationary temperature via a concerted switching on and switching off of the heating.

In a variation of one embodiment, the heater can be operated cyclically. When the heating element or elements are in a current-free state, (i.e., no ohmic heat is discharged) the heat effect at the temperature sensor may essentially be determined by the temperature of the fluid which flows out of the basin into the flow-through path. As a result, the temperature of the fluid in the basin may be determined. During periods of heating, the temperature of the fluid may be determined by the heating up via the heating element or elements. During cyclic heating, not only a temperature monitoring function through the temperature sensor may be realized, but also a determination at intervals of the temperature of the fluid in the basin can be made. Alternatively to the cyclic operation of the heater, an additional temperature sensor and, in particular, a temperature sensor for the entry temperature for fluid entering the flow-through path may, also be provided in order to determine the basin temperature.

It is advantageous when the evaluating device for the measurement signals of the (at least one) temperature sensor carries out a plausibility check in order to be able to bring about an immediate switching off of the heating in the case of any sensor malfunctions.

It is favorable when the heater includes at least one additional temperature sensor. As a result, when, for example, the temperature sensors in the heater are connected independently of one another, safety monitoring can also be carried out when a single temperature sensor breaks down or, in the case of significant deviations in the results of measurements, an immediate safety switch-off can be brought about. An increase in redundancy may, therefore, be achieved as a result of a plurality of temperature sensors in the heater. For the same reason, it is advantageous when an additional safety loop is provided for increasing the redundancy. The safety loops with associated temperature sensors should, for this purpose, be independent of one another.

Further embodiments of the invention relate to a heating method for a fluid in a basin, with which fluid from the basin flows through a heating path which is located outside a reservoir of the basin and is heated by a heater with at least one heating element.

In accordance with embodiments of the present invention, a heating method which can be carried out in a simple and reliable manner is provided. This is accomplished in accordance with embodiments of the invention, in that a measurement of the temperature is carried out for monitoring the heating loop with respect to dry running in the heater.

The advantages of a heating method according to embodiments of the invention have already been explained in conjunction with the above-described heating device.

It is particularly favorable when the measurement of the temperature is carried out at or in the vicinity of a location of the heating path at the highest point with respect to the direction of gravity. The measurement of the temperature is carried out, in particular, at a cross section of the heating path which is at or in the vicinity of the highest point with respect to the longitudinal direction of the heating path. In this way, the temperature is monitored just at the most critical point of the heater. A bubble of steam can form at the highest point or steam or air can accumulate, whereby the discharge of heat from the heater is impaired. As a result, this can, cause overheating locally. This may be monitored in an effective way with a corresponding positioning of the temperature sensor.

Embodiments of the invention relate to a heating device for a fluid in a basin, comprising a flow-through path which can be positioned outside a fluid reservoir of the basin, a heater which is arranged in the flow-through path and past which the fluid can flow for the purpose of heating up and at least one heating element which is arranged in the heater. Such a heating device, which is used, in particular, for a whirlpool (spa) or a bath tub, is known, for example, under the name Laing Infinity Heater.

The heating is based on the principle of continuous flow heating (e.g., fluid is coupled out of the basin and heated up when passing through the flow-through loop). Heated fluid is then coupled into the basin again. In this respect, there is the basic problem that malfunctions can occur which lead to dry running of the flow-through path or loop. A reduced amount of fluid then flows in the flow-through loop or no fluid at all flows through it. In such cases, it is necessary to switch the heating off.

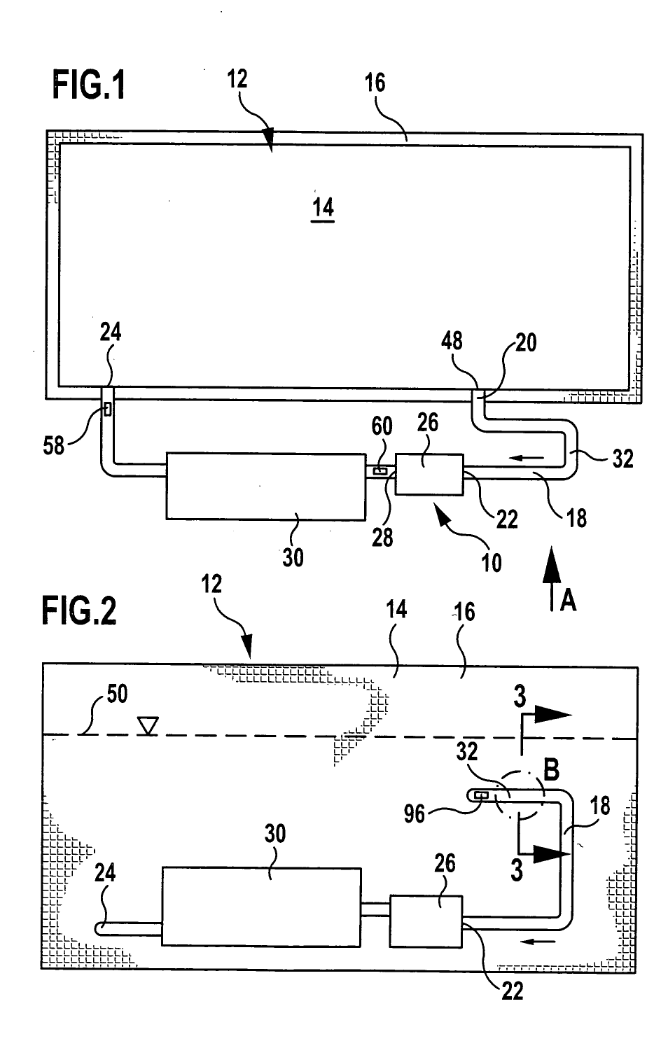

Referring now to the Figures, an inventive heating device, of which one embodiment is shown in FIG. 1 and designated as a whole as 10, is used for heating or maintaining a temperature of a fluid in a basin 12. The basin 12 has a reservoir 14 for the fluid which is contained within basin walls 16.

The basin 12 with fluid accommodated in the reservoir 14 may be a whirlpool or a bath tub, for example, with water to be heated.

In the illustrated embodiment, the heating device 10 is arranged outside the reservoir 14 and positioned, for example, on an outer side of the basin wall 16 or positioned on a corresponding holding frame with respect to the basin 12. The heating device 10 comprises a flow-through path 18 which is arranged outside the reservoir 14 and which comprises a heating path, in which the fluid can be heated. This flow-through path can be in the form of a loop.

The flow-through path 18 has an entry end 20, via which fluid from the reservoir 14 can enter the flow-through loop 18. For this purpose, the basin wall 16 may be provided with a continuous recess and may have an opening so that fluid from the reservoir 14 can be guided through the heating device 10.

Furthermore, the flow-through loop 18 has an exit end 22 which is in fluid-effective communication with an entry point 24 for fluid heated up by the heating device 10 into the reservoir 14. The exit end 22 may be coupled directly to the entry point 24 in a fluid-effective manner. It may also be provided, as shown in FIG. 1, for the exit end 22 of the flow-through loop 18 to be coupled to an entry to a circulation pump 26, wherein an exit 28 of the circulation pump 26 is then coupled to the entry point 24 into the reservoir 14 of the basin 12.

In the case of whirlpools, an ozone device 30 is generally provided which is connected in front of the entry point 24 for fluid into the reservoir 14 (with respect to the direction of flow of the fluid) and is arranged, for example, between the entry point 24 and the exit 28 of the circulation pump 26. The fluid coupled into the reservoir 14 of the basin 12 can previously be disinfected by way of ozonization via the ozone device 30. The ozone device 30 may be connected behind the heating device 10 and its flow-through path 18.

In the case of bath tubs, no ozone device is generally provided, and the exit 28 of the circulation pump 26 is coupled directly to the entry point 24 of the reservoir 14.

In the case of a heating device 10 positioned on the basin 12, the entry end 20 of the flow-through loop 18 of the heating device 10 is generally, in the case of whirlpools, located above the exit end 22 of the flow-through loop 18 with respect to the direction of gravity. As a result, fluid from the reservoir 14 is removed at a higher level than it is coupled into the reservoir 14 again.

In the case of bath tubs, the exit end of the flow-through path is generally at a higher level than the entry end (e.g., fluid to be heated is removed from the basin at the bottom and hot fluid flows into the basin above this).

The flow-through path 18 is formed in a tube 32 which can be bent in order to be able to position the heating device 10 on the basin 12 in an optimum manner.

The tube 32 has an extension in a longitudinal direction in order to form in this way the flow-through path 18 for the fluid coupled out of the reservoir 14. This extension is not necessarily linear.

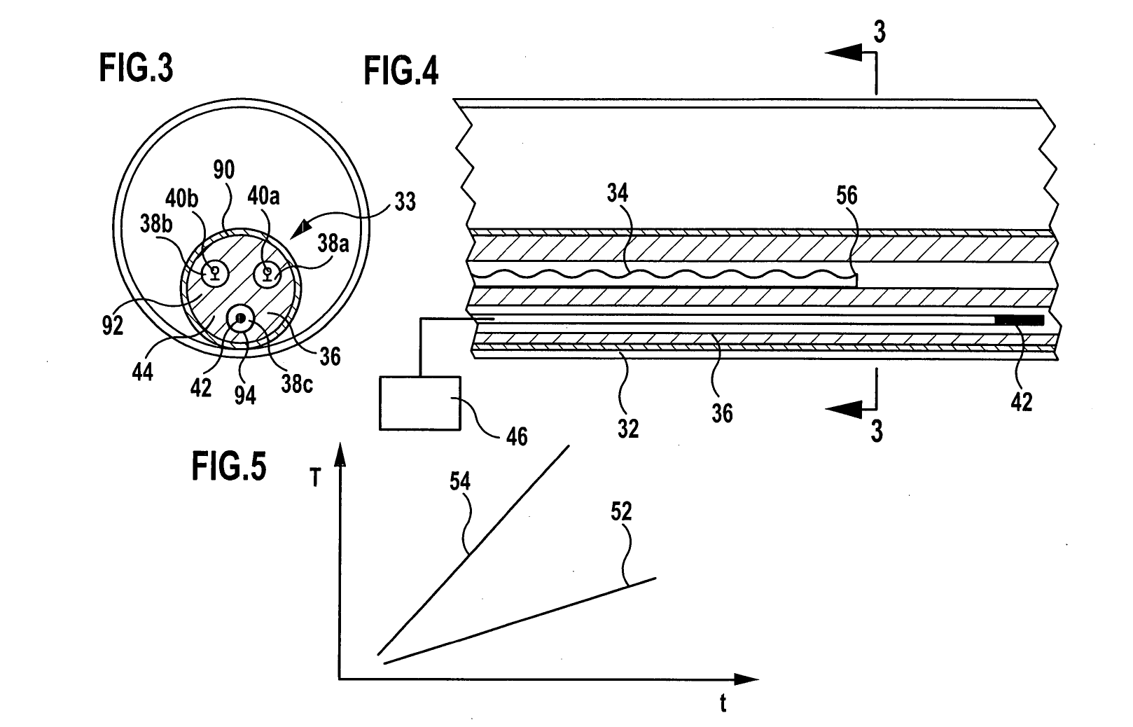

A heater 33 with at least one heating element 34 (FIGS. 3, 4) is arranged in the tube 32 and, therefore, in the flow-through path, and this heater extends along the tube 32, adapted to its shape and, for example, to the curvatures in it. The heating element 34 follows this course. The heating element 34 may be an electric resistance heating element. The fluid flowing past the heater 33 may be heated via such a heating element 34 over a relatively long distance, wherein the specific power density per area can be kept small.

In the embodiment shown in FIGS. 3 and 4, the heater 33 arranged in the tube 32 is designed as a heating rod 36. This heating rod 36 comprises a plurality of recesses 38a, 38b, 38c extending in its longitudinal direction and having, for example, a circular cross section. In the embodiment shown in FIG. 3, three such recesses are provided. Elongated heating elements 34 are arranged in the respective recesses 38a and 38b, namely heating elements 40a and 40b. A temperature sensor 42 is arranged in the third recess 38c. The temperature sensor 42 may be, for example, a thermoelement. Corresponding signal lines of this temperature sensor 42 are then guided out via the recess 38c.

The heating rod 36 has a metallic sleeve 90 which serves as a protective casing for an area 92 of solid material (FIG. 3). The recesses 38a, 38b and 38c are formed in this area 92 of solid material. The material for the area 92 of solid material is preferably a solid-state material with a high heat conductivity which is electrically insulating. For example, magnesium oxide may be used as such a material.

The heating elements 40a, 40b are each surrounded by the solid material, wherein these heating elements 40a, 40b touch the area of solid material in order to provide thermal contact. (In FIG. 3, the contact is not shown for reasons of illustration). The temperature sensor 42 likewise touches the solid material in order to bring about thermal contact. The temperature sensor 42 is likewise surrounded by solid material. In addition, solid material is arranged between the temperature sensor 42 and each of the heating elements 40a and 40b in order to provide thermal contact between the heating elements 40a, 40b and the temperature sensor 42 in this way.

The temperature sensor 42 is therefore arranged in the heater 33 and measures the temperature in the heater 33.

The heating rod 36 is securely arranged in the tube 32 and can, be bent with the tube 32. For example, the heating rod 36 with heating elements 40a and 40b and temperature sensor 42 is securely positioned in the tube 32, and during the bending of the tube 32 into the desired position, the heating rod 36 is bent with it.

As a result of the heating rod 36 in the flow-through path 18, fluid flowing past it can be heated up with little heat losses and the temperature sensor 42 supplies an exact result of the prevailing temperature ratios at short reaction times on account of the good transfer of heat within the heater 33.

In the free cross section of the tube 32 around the heating rod 36, the fluid can flow in the flow-through path 18 along the heating rod 36, which can be heated by the elongated heating elements 34, and be heated up along its flow loop. As a result, a continuous flow heater for the fluid is formed by means of the heating device 10.

The heating device 10 comprises a temperature monitoring device 46 (FIG. 4) which serves, for example, to switch off the heating during critical malfunctions. The temperature monitoring device 46 is connected to the temperature sensor 42. Cases of malfunction can result when, for example, the circulation pump 26 is blocked. A further, critical case of malfunction may occur when the flow-through path 18 runs dry (i.e., no fluid is flowing through the flow-through path 18). A protection against dry running may be realized by means of the temperature monitoring device 46. Such dry running may be caused, for example, when an exit point 48 of the basin 12 which is connected to the entry end 20 of the flow-through path 18 is blocked. Such dry running can also be caused by the fact that the level of fluid 50 falls below the exit point 48 (see FIGS. 1 and 2).

The recess 38c for the temperature sensor 42 is formed by a small tube 94 in the heating rod 36. In this small tube 94, the temperature sensor can be positioned in longitudinal direction of the small tube 94 and, therefore, in longitudinal direction of the heating rod 36 and, therefore, at a specific location in the flow-through loop 18 when a heater 33 is positioned in the flow-through loop 18. At least during the production of the heating rod 36, the temperature sensor 42 may be freely positionable along the heating rod 36 (i.e., freely positionable in the small tube 94 in its longitudinal direction).

In accordance with embodiments of the invention, it may be provided for the temperature sensor 42, when a heating device 10 is arranged on the reservoir 14, to be arranged at or in the vicinity of the highest point (with respect to the direction of gravity and the longitudinal direction of the flow-through path 18) of the flow-through path 18. This relates essentially to the longitudinal direction of the flow-through path 18 (i.e., the cross-sectional area of the flow-through section which is located at or in the vicinity of the highest point with respect to the direction of gravity. The vertical positioning of the heating rod 36 in this cross-sectional area may be of secondary importance. For example, the temperature sensor 42 need not be located at the top in this cross-sectional area but can also be positioned at the bottom, as indicated in FIG. 3.

Basins 12 may be of different designs. Accordingly, the flow-through path 18 can also extend in different ways. The highest point of the flow-through path 18 with respect to the direction of gravity is a critical point since steam or penetrating air can accumulate at this point when enough fluid is no longer flowing through the flow-through path 18. This area is, therefore, the most critical in relation to local overheating and with the positioning of the temperature sensor 42 in this area, the critical area can, therefore, be monitored with a short reaction time.

On account of the positioning of the temperature sensor 42 in the heating rod 36 in the small tube 94, the temperature sensor may, at least during production, be positioned at or in the vicinity of that point of the heating rod 36 which, again, is seated at or in the vicinity of the highest point of the flow-through path 18 with respect to the direction of gravity when a heating device 10 is mounted on the basin 12.

When fluid flows past the heating rod 36, the fluid is heated up and the heating rod 36 cools or rather is kept at a stationary temperature during stationary conditions. When the flow-through conditions in the flow-through path 18 change, for example, when the circulation pump 26 is blocked or during dry running, the amount of fluid flowing through the flow-through path 18 may be reduced and the amount of fluid which flows past the heating rod 36 may be accordingly reduced. As a result, the temperature at the heating rod 36 is increased when the current applied to the heating elements 40a and 40b is unchanged, and this rise in temperature can be measured by the temperature sensor 42.

Since the temperature sensor 42 facilitates an exact measurement of the temperature with short reaction times on account of being embedded in the heating rod 36, an intelligent control or regulation of the switching-off of the heating can be realized via the temperature monitoring device 46.

The temperature monitoring device 46 may include an evaluating device which determines the temperature as a function of time and evaluates the temperature signals supplied by the temperature sensor 42 as to their temporal development. As a result, the type of malfunction can be concluded from a rise in temperature. This is shown schematically in FIG. 5. For example, if the circulation pump 26 is blocked, wherein such a blockage is generally an event limited in time, the temperature then rises slowly with the time, as indicated schematically by the temperature curve 52. If, on the other hand, a dry running of the flow-through path 18 with formation of steam occurs or air has penetrated the loop, the rise in temperature is much more rapid in time, as indicated by the temperature curve 54. The evaluating device of the temperature monitoring device 46 can conclude from the rise in the temperature curve whether a critical or an uncritical case of malfunction is present. Depending on the result of this determination, a specific action can be carried out, wherein these reactions can also be graded as a function of time and adapted.

If, for example, a slow rise in temperature considered to be uncritical is determined, the heating may be switched off and, in the case of malfunctions considered to be reversible, corresponding signals can be transmitted to a primary control device for the basin 12 in order to initiate corresponding correction processes. These correction processes may alternatively be initiated by the temperature monitoring device 46 itself. For example, the heating is switched on again after a certain time without any external operator intervention being necessary. If, on the other hand, a malfunction is considered to be critical and, in particular, considered not to be reversible, such as, for example, dry running with formation of steam, the heating in the flow-through path 18 is switched off permanently through the temperature monitoring device 46. The heating elements 40a and 40b are switched to current-free. A corresponding signal is transmitted to the primary control device which again emits an error signal. A repair of the malfunction may require external operator intervention.

In this connection it is particularly advantageous when an additional temperature sensor independent of the temperature sensor 42 is provided for redundancy and is arranged in the vicinity of this temperature sensor 42. It is also favorable when critical elements of the temperature monitoring device 46, such as, for example, corresponding processors and relays which form a safety loop are doubled in number in order to also provide the redundancy in this way. As a result, a switching off of the heating may be brought about in the case of critical malfunctions even when one temperature sensor fails.

It is advantageous when the evaluating device of the temperature monitoring device 46 carries out a plausibility check for the signals of the temperature sensor 42 or, in the case of several temperature sensors, performs the check for signals from each of the sensors. As a result, malfunctions of the temperature sensor 42 itself can be recognized.

It may also be provided for the heating elements 40a and 40b to be supplied with electrical energy cyclically in order to achieve a cyclic heating in the flow-through path 18. During the non-heating times of the heating rod 36, the temperature sensor 42 essentially measures the temperature of the fluid which enters the flow-through path 18 via the exit point 48 and, therefore, the temperature of the fluid in the reservoir 14. The temperature of the fluid 50 in the basin 12 may therefore be determined via the heating device 10. The temperature monitoring device 46 can pass this determined basin temperature to the primary control device.

In a variation of one embodiment, as shown in FIG. 4, it is provided for the temperature sensor 42 to project with its front end beyond an end 56 of the heating element or elements 34 so that the distance between the front end of the temperature sensor 42 and the corresponding end of the heating element or elements 34 is, for example, on the order of 50 mm. The temperature sensor 42 is, as a result, located spatially closer to the reservoir 14 of the basin 12. As a result, the temperature sensor 42 can determine the temperature of fluid directly at the entry end 20 prior to its being heated up, and the temperature of the fluid in the reservoir 14 of the basin 12 can be determined even in the case of non-cyclic, or continuous, operation of the heating element or elements 34. When the distance of the temperature sensor 42 to the heating element or elements 34 is kept small, a reliable temperature monitoring function can still be ensured.

Alternatively, it may be provided for the heating element or elements 34 to have a non-heatable end area which has, for example, an extension on the order of 50 mm. In this case, the temperature sensor 42 can be positioned essentially flush with the heating element or elements 34 at the entry end 20, wherein the temperature of fluid in the reservoir 14 of the basin 12 can still be determined via the temperature sensor 42 and the temperature monitoring function ensured at the same time.

A separate temperature sensor 96 (FIG. 2) can also be provided and is arranged in the vicinity of the entry end 20 of the flow-through path 18. The entry temperature of fluid into the flow-through path 18 and the basin temperature can be determined via this temperature sensor. This temperature sensor 96, which acts as a temperature sensor for the entry temperature for the flow-through path 18, may be coupled to the temperature monitoring device 46.

It is provided for the evaluating device of the temperature monitoring device 46 to determine the absolute temperature (and not only the rise in temperature) alternatively or in addition. For example, immediately after switching on when the fluid in the basin 12 is still hot and hot fluid flows out of the basin 12 into the flow-through path 18, there is a sharp rise in temperature which is not, however, attributable to a case of malfunction but rather to the relatively rapid heating up after switching on. By determining the absolute temperature, this state can be detected, wherein it is then apparent, via the evaluating device taking the absolute temperature into consideration, that no case of malfunction is present and, therefore, no unnecessary switching off of the heating is carried out.

In addition, by determining the absolute temperature it is possible to recognize the case where the heating is switched on and off several times one after the other externally and, as a result, an unnecessary emergency switching off is again avoided.

A correction routine may also be carried out during the initial switching on in order to recognize a steep rise in temperature following initial switching on and then not to carry out any unnecessary switching off of the heating until stationary conditions have been reached (but without exceeding predetermined safety thresholds).

In addition, it is, for example, possible to realize a restart blocking device by means of the inventive temperature monitoring device 46 when a switching off of the heating in the flow-through path 18 on account of a critical case of malfunction has been carried out. As a result, it is ensured that the heating cannot be switched on again until the heating element or elements 34 have cooled to such an extent that no critical states are present or the malfunction has been repaired by means of an external intervention.

The switch-off temperature for the heating in the flow-through loop 18 may be set, for example, such that any overheating and any residual heat of the fluid located in the heating device 10 are also taken into account, so that no risk occurs when this amount of fluid flows into the reservoir 14.

The embodiments of heating device may also be used in conjunction with bath tubs as basin 12. Bath tubs generally have a reservoir 14 with a smaller volume than is the case of a whirlpool. An ozone device 30 is, likewise, generally not provided. The flow-through path 18 is, likewise, generally shorter than in the case of a whirlpool.

It may be provided for an additional temperature sensor 58 (FIG. 2) to be installed as temperature sensor for the exit temperature for the flow-through path 18 in conjunction with bath tubs as basin 12. This temperature sensor 58 is arranged, in particular, at or in the vicinity of the entry point 24 into the basin 12 in order to measure the temperature of fluid entering the basin 12 (which comes from the flow-through path 18). If the outlet 28 of the circulation pump 26 is coupled directly to the entry point 24 of the basin 12 with a short line section, the temperature sensor 58 is seated in the vicinity of the outlet 28 of the circulation pump 26.

Monitoring against fluid entry temperatures which are too high for the fluid flowing into the reservoir 14 may also be realized through of the temperature sensor 58. A switch-off signal for the circulation pump 26 may be generated via the temperature monitoring device 46, through which the temperature sensor 58 is connected, when, for example, too high a temperature is detected in order to avoid any risk of scalding at the entry point 24. Such a temperature sensor 58 can also be arranged, in principle, in the vicinity of the exit end 22 of the flow-through path 18 (e.g., connected in front of the circulation pump 26).

It can also be provided, for example, for several temperature sensors to be present, as also indicated, for example, in FIG. 1 by the reference numeral 60, in order to measure the temperature at several measurement points. Greater protection against overheating, also in the case of reservoirs 14 with smaller intake volumes and with a smaller amount of circulating fluid, can then be achieved altogether.

On account of the arrangement of at least one temperature sensor 58 for the exit temperature of the flow-through path 18, a greater sensitivity to and, therefore, a greater protection against overheating is obtained not only during the passage through the heating device 10 but also with respect to the entry of fluid into the basin 12.

Embodiments of the temperature monitoring device 46 may have a specific intelligence. It may be established, for example, via this device by means of its evaluating device whether a reversible stagnation (e.g., an uncritical reversible case of malfunction) or a permanent dry running is present. Depending on the result of detection, the corresponding steps are then initiated, such as, for example, production of an error report or transmission of corresponding signals for the initiation of a correction routine, switching off of the heating, or alternatively or in addition, switching off of the circulation pump 26. In this respect, any unnecessary permanent switching off of the heating can be minimized.

As a result of the arrangement of the temperature sensor 42 of the heater 33 at or in the vicinity of the spatially highest point of the flow-through loop 18 with respect to the direction of gravity, an exact determination of the temperature with quick reaction times may be carried out. As a result, the intelligent temperature monitoring function may again be realized.

The inventive temperature monitoring device 46 can recognize and differentiate malfunctions as a result and pass corresponding signals to a primary control device of the basin 12.

Any unnecessary switching off of the heating on account of uncritical cases of malfunction may be prevented. Altogether, the ease of operation of the inventive heating device is increased as a result since a high safety with respect to switching off in the case of dry running is achieved. On the other hand, it may be recognized whether uncritical cases of malfunction are present which do not make a permanent switching off and external operator intervention necessary.

The flow of fluid through the flow-through path 18 may be determined and monitored via the evaluating device with a known heating capacity via the temperature sensor 96 for the entry temperature for the flow-through loop 18 and the temperature sensor 58 for the exit temperature. If the through-flow of fluid is reduced over a longer period of time to too great an extent, this may indicate filter problems with respect to a filter through which the fluid must pass when flowing through the fluid guide means outside the basin 12. A corresponding filter signal can then be generated in order to draw the attention of the user to the fact that the filter needs to be checked or exchanged.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

1. A heating device for a fluid in a basin, comprising:
a flow-through path for a fluid reservoir of the basin;
a heater arranged in the flow-through path, the fluid being able to flow past said heater for the purpose of heating up;
at least one heating element arranged in the heater; and
a temperature sensor positioned in the heater and in thermal contact with the at least one heating element.

2. The heating device according to claim 1, wherein the heater comprises an area of solid material, said solid material having a high thermal conductivity.

3. The heating device according to claim 2, wherein the material for the area of solid material is an electrical insulator.

4. The heating device according to claim 2, wherein the at least one heating element is surrounded by said solid material.

5. The heating device according to claim 2, wherein the temperature sensor is surrounded by said solid material.

6. The heating device according to claim 2, wherein said solid material is arranged between the temperature sensor and the at least one heating element.

7. The heating device according to claim 1, wherein the temperature sensor is freely positionable in a longitudinal direction of the heater at least during production of the heater.

8. The heating device according to claim 1, wherein the temperature sensor is arranged in a recess of the heater.

9. The heating device according to claim 8, wherein the recess extends in a longitudinal direction of the heater.

10. The heating device according to claim 1, wherein the heater has a metallic sleeve.

11. The heating device according to claim 1, wherein the temperature sensor is seated at or near a highest point of the heater in the flow-through path with respect to the direction of gravity.

12. The heating device according to claim 1, wherein the flow-through path is formed in a tube.

13. The heating device according to claim 12, wherein the tube is adapted to be bent.

14. The heating device according to claim 13, wherein the heater is adapted to be bent with the tube.

15. The heating device according to claim 1, wherein the heater includes a heating rod seated in the flow-through path.

16. The heating device according to claim 1, wherein the at least one heating element is an electric resistance heating element having an extension in a longitudinal direction of the heater.

17. The heating device according to claim 1, wherein the temperature sensor is arranged with a front end being offset in relation to an adjacent heating end of the at least one heating element.

18. The heating device according to claim 17, wherein said front end of said temperature sensor is offset from said adjacent heating end by approximately 50 mm.

19. The heating device according to claim 1, wherein a circulation pump is integrated with said flow-through path.

20. The heating device according to claim 18, further comprising the circulation pump is coupled to an exit end of the flow-through path.

21. The heating device according to claim 1, wherein time-dependent temperature measurements are adapted to be carried out by the temperature sensor.

22. The heating device according to claim 1, further comprising a temperature monitoring device, the temperature sensor being coupled to said device, said device being adapted to control operation of said heater.

23. The heating device according to claim 22, wherein said device is adapted to selectively switch on and off heating of the fluid.

24. The heating device according to claim 22, wherein the temperature monitoring device comprises an evaluating device for evaluating signals of the temperature sensor.

25. The heating device according to claim 24, wherein said evaluating device is adapted to determine the time-dependent increase in temperature.

26. The heating device according to claim 24, wherein said evaluating device is adapted to determine an absolute temperature.

27. The heating device according to claim 1, further comprising an additional temperature sensor for determining the temperature of fluid entering the flow-through path.

28. The heating device according to claim 27, wherein the additional temperature sensor is coupled to a temperature monitoring device.

29. The heating device according to claim 1, further comprising an additional temperature sensor for determining the temperature of fluid exiting from the flow-through path.

30. The heating device according to claim 29, wherein the additional temperature sensor is coupled to a temperature monitoring device.

31. The heating device according to claim 1, further comprising a temperature sensor for the entry temperature of fluid flowing through the flow-through path into the basin.

32. The heating device according to claim 1, further comprising additional temperature sensors for determining temperatures at entry and exit of the flow-through path and an evaluating device adapted to determine the flow of fluid through the heating device via the entry temperature of the fluid into the flow-through path and the exit temperature out of the flow-through path or out of the heating device.

33. The heating device according to claim 32, wherein a filter signal is adapted to be generated via the determination of the through-flow of the fluid.

34. The heating device according to claim 23, wherein a switch-off temperature for the heating is set such that residual heat and overheating of the fluid when entering the basin are taken into consideration.

35. The heating device according to claim 22, wherein the temperature monitoring device comprises a restart blocking device.

36. The heating device according to claim 22, wherein the temperature monitoring device takes an initial heating-up process into consideration.

37. The heating device according to claim 1, wherein the heater is adapted to be operated cyclically.

38. The heating device according to claim 1, wherein the heater comprises at least one additional temperature sensor.

39. The heating device according to claim 38, further comprising at least one additional safety loop for redundancy.

40. The heating device according to claim 1, wherein said flow-through path is positioned outside said fluid reservoir.

41. A heating method for a fluid in a basin;
flowing a fluid through a heating path located outside a reservoir of the basin, said path being heated by a heater with at least one heating element; and
measuring a temperature at least at one point along said path for monitoring the heating path with respect to dry running of the heater.

42. The heating method according to claim 41, wherein the measurement of the temperature is carried out at or near a location of the heating path at the highest point with respect to the direction of gravity.
